(19) United States
(12) Patent Application Publication
(10) Pub. No.: US 2007/0252750 A1
(43) Pub. Date: Nov. 1, 2007

(54) Method and Device for Filtering Responses in a Secondary Radar Extractor

(75) Inventors: Billaud Philippe Jean, Fontenay Aux Roses (FR); De Volder Claude Rene, (Les Carrieres) Auffargis (FR)

Correspondence Address: LOWE HAUPTMAN & BERNER, LLP, 1700 DIAGONAL ROAD, SUITE 300, ALEXANDRIA, VA, 22314, US

(73) Assignee: THALES, Neuilly Sur Seine (FR)

(21) Appl. No.: 10/575,084

(22) PCT Filed: Sep. 29, 2004
(86) PCT No.: PCT/EP04/52359

§ 371 Date: Apr. 7, 2006

(30) Foreign Application Priority Data
Oct. 10, 2003 (FR) 0311892

(51) Int. Cl. G01S 13/74

(52) U.S. Cl. 342/40

(57) ABSTRACT

The present invention lies in the field of the filtering of the responses received by an extractor situated downstream of a receiver of a secondary radar. An aim of the invention is to propose a defruiter making it possible to take account of the carriers having a significant radial speed with respect to the secondary radar. According to the invention, a first response received in a recurrence i is considered synchronous with a second response received in another recurrence j if:
ρⱼε└ρᵢ−Vₘₐₓ×(tⱼ−tᵢ);ρᵢ−Vₘᵢₙ×(tⱼ−tᵢ)┘ when tⱼ>tᵢ, or
ρⱼε└ρᵢ−Vₘᵢₙ×(tⱼ−tᵢ);ρᵢ−Vₘₐₓ×(tⱼ−tᵢ)┘ when tⱼ<tᵢ, where:
Vₘᵢₙ and Vₘₐₓ are respectively the minimum and maximum radial speed of the transponders with respect to the secondary radar, positive by convention for a transponder approaching the radar, the speeds Vₘᵢₙ and Vₘₐₓ possibly being equal, at least Vₘᵢₙ or Vₘₐₓ being nonzero;
ρᵢ and ρⱼ are respectively the distance at which the transponder has been detected in recurrence i and in recurrence j;
tᵢ and tⱼ are respectively the instant of emission of the interrogation in recurrence i and in recurrence j.

The defruiter according to the invention can comprise a single synchronous filter (for which Vₘᵢₙ=−Vₘₐₓ for example) or a set of filters operating in parallel, each filter processing different radial speed bins.

The present invention lies in the field of the filtering of the responses received by an extractor situated downstream of a receiver of a secondary radar.

A secondary radar makes it possible to obtain cooperative carrier vehicles, equipped with transponders (radar responder), coded information on the identity of the carrier and other coded information (altitude, signaling of radio faults, diversion, distress).

Secondary radars are used both in civil and military applications, in the guise of surveillance radar (known as a “Secondary Surveillance Radar” or SSR) or anti-collision radar (airborne radar). The International Civil Aviation Convention, also called the ICAO standard (International Civil Aviation Organization) defines a communication protocol for secondary radars in its annex 10 (Aeronautical Telecommunications), volume IV (Surveillance radar and anti-collision systems). The ICAO standard defines several interrogation modes, such as modes A, C and S. Mode S is distinguished from modes A and C in that it allows selective interrogation of aircraft by the use of an identification number specific to each aircraft. However, the mode S interrogations and responses are long with respect to the interrogations and the responses in mode A or C.

We customarily distinguish, among the responses arriving at a secondary radar antenna, so-called synchronous responses which are the responses of transponders, situated in the interrogation lobe of the radar, to the interrogations of this radar, and so-called asynchronous responses, which are the responses of the transponders situated in the interrogation lobe of the radar to interrogations originating from other radars.

The number of asynchronous responses can turn out to be very significant, in particular in the application to air navigation surveillance, where the density of aircraft in an azimuthal sector may be very large and the number of secondary radars very high. If nothing is done to eliminate these asynchronous responses, the processing of the responses as a whole (synchronous and asynchronous), downstream of the receiver, may be saturated.

In order to eliminate the asynchronous responses it is known to use a device called a defruiter, allowing the secondary radar to eliminate from among all the responses received those which are not the responses to its own interrogations.

A defruiter comprises a synchronous filter which verifies that the responses received in the course of the listening periods following each of the interrogations are synchronous with the interrogations of the radar. The interrogation and the listening period following it constitute what is called a recurrence. The synchronous filter therefore verifies whether the responses are received at the same instant T (time separating the interrogation from the response) of their recurrence. The defruiter makes a count of the number P of responses considered synchronous by the synchronism test. The defruiter transmits these responses to the extractor only if the ratio P/N, where N is the number of recurrences to which the synchronism test is applied, is greater than a determined threshold k.

Patent application FR 2 692 996 describes a synchronism test in which the responses are regarded as synchronous if they are received in time intervals [T−96 ; T+τ], τ designating a tolerance time. This tolerance time makes it possible to take account in particular of the tolerance in the response times of the transponders and of the uncertainty introduced by digital sampling.

If a carrier is imbued with a radial speed with respect to the secondary radar, the synchronism test may conclude wrongly that some of the responses of its transponder are not synchronous, the carrier having moved by an overly significant distance between the two interrogations. Stated otherwise, the use of such a defruiter causes the loss of a certain number of synchronous responses.

But, with the use of mode S, it is no longer possible to tolerate the loss of synchronous responses. Specifically, the principle of mode S aircraft selective interrogation requires significant time. Accordingly the interrogation frequency in the other modes has considerably decreased, going for example from 450 Hz to 150 Hz. The number of recurrences N to which the synchronism test can be applied has decreased accordingly. Consequently, such a defruiter is not satisfactory in relation to carriers exhibiting a non-negligible radial speed within a mode S radar.

Similarly, if the speed of rotation of the secondary radar is slow, even for targets of average radial speed, the movement in distance of the latter within the duration of the lobe is significant rendering it asynchronous with a contemporary defruiter. But it is not possible to tolerate the loss of synchronous responses without compromising the performance of the radar.

An aim of the invention is to propose a more effectual defruiter, making it possible to take account of carriers whose radial speed with respect to the secondary radar is non-negligible.

For this purpose the invention relates in particular to a method for defruiting the transponder responses received by a secondary radar in response to interrogations emitted by the radar in a recurrent manner, a recurrence being formed by the interrogation and the responses received in the course of a listening period following the interrogation, the defruiting method comprising a test of the synchronism of the responses received in various recurrences, characterized in that a first response received in a recurrence i is considered synchronous with a second response received in another recurrence j if:
ρⱼε└ρᵢ−Vₘₐₓ×(tⱼ−tᵢ);ρᵢ−Vₘᵢₙ×(tⱼ−tᵢ)┘ when tⱼ>tᵢ, or
ρⱼε└ρᵢ−Vₘᵢₙ×(tⱼ−tᵢ);ρᵢ−Vₘₐₓ×(tⱼ−tᵢ)┘ when tⱼ<tᵢ,
where:
Vₘᵢₙ and Vₘₐₓ are respectively the minimum and maximum radial speed of the transponders with respect to the secondary radar, positive by convention for a transponder approaching the radar, the speeds Vₘᵢₙ and Vₘₐₓ possibly being equal, at least Vₘᵢₙ or Vₘₐₓ being nonzero;
ρᵢ and ρⱼ are respectively the distance at which the transponder has been detected in recurrence i and in recurrence j;
tᵢ and tⱼ are respectively the instant of emission of the interrogation in recurrence i and in recurrence j.

Other characteristics and advantages of the invention will appear on reading the following detailed description presented by way of nonlimiting illustration and offered with reference to the appended figures, which represent:

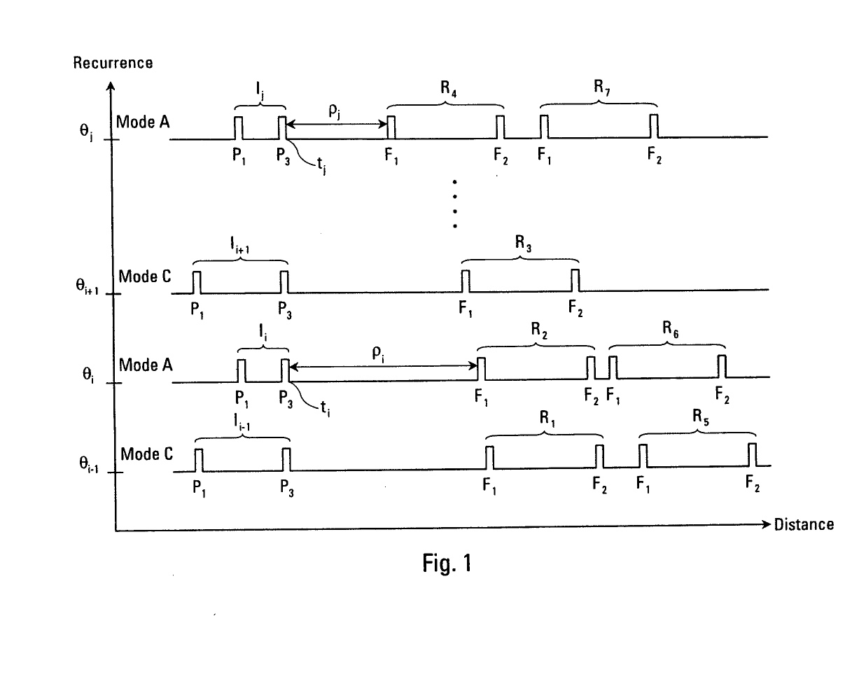

FIG. 1, an example of recurrences of a secondary radar;

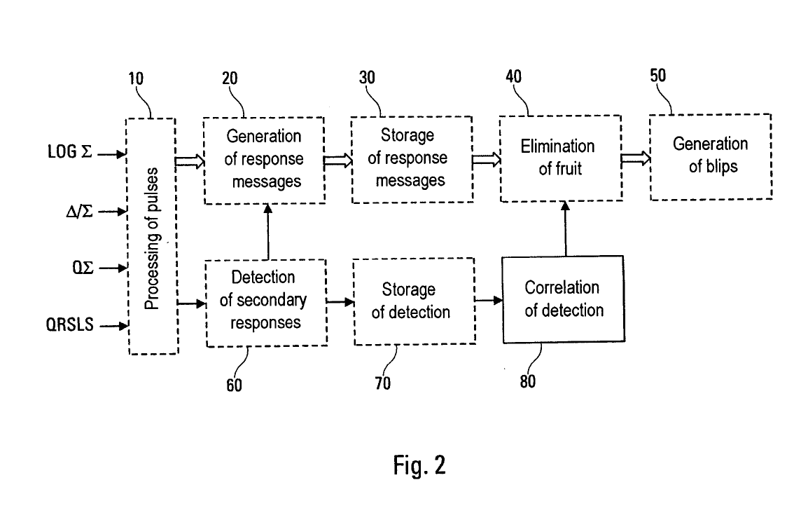

FIG. 2, an exemplary receiver of a secondary radar;

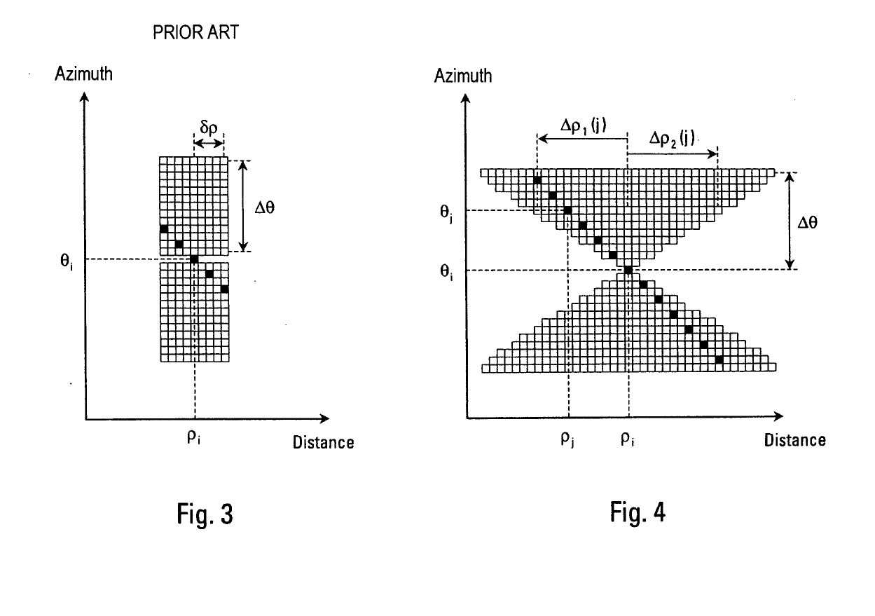

FIG. 3, an exemplary sliding window used to perform a synchronism test in a defruiting method of the prior art;

FIGS. 4 to 6, examples of sliding windows used to perform a synchronism test in a defruiting method according to the invention;

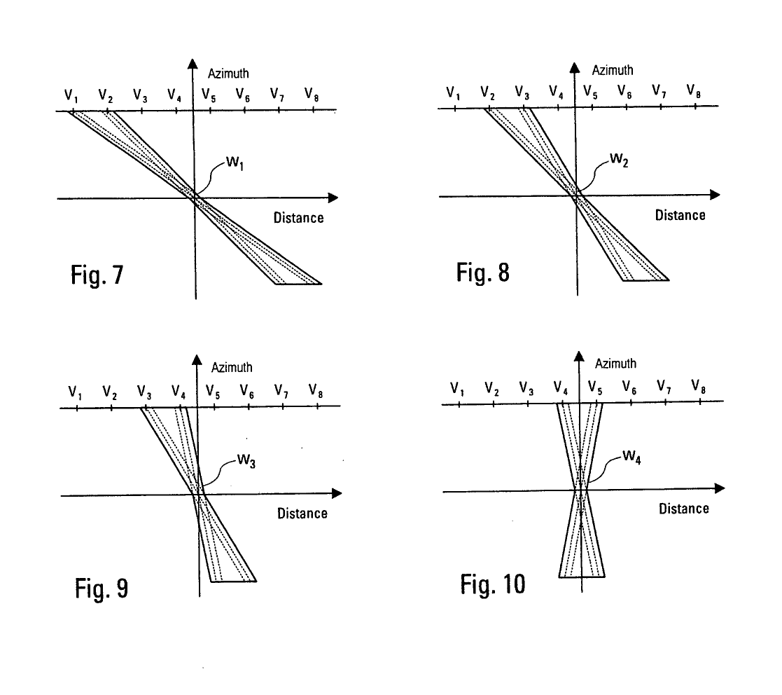

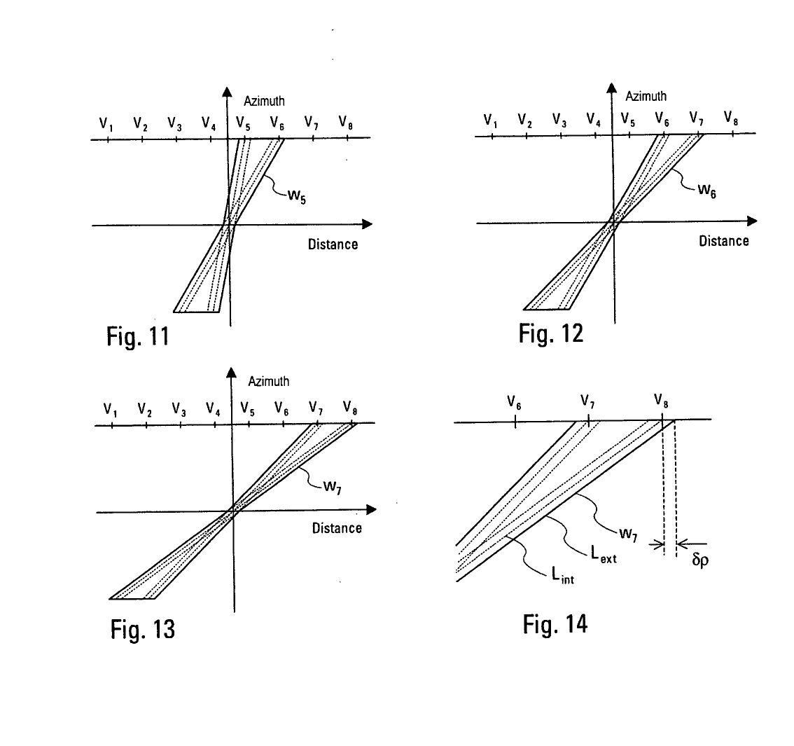

FIGS. 7 to 14, an exemplary advantageous implementation of the invention in which a set of synchronous filters in parallel is used;

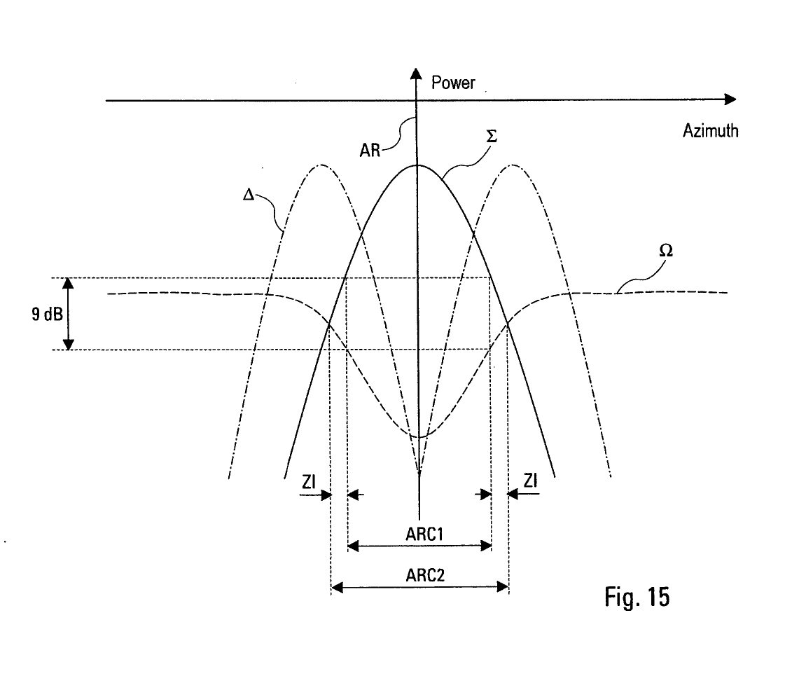

FIG. 15, an example of antenna patterns of a secondary radar in a power-azimuth reference frame, the power being represented as ordinate on a logarithmic scale;

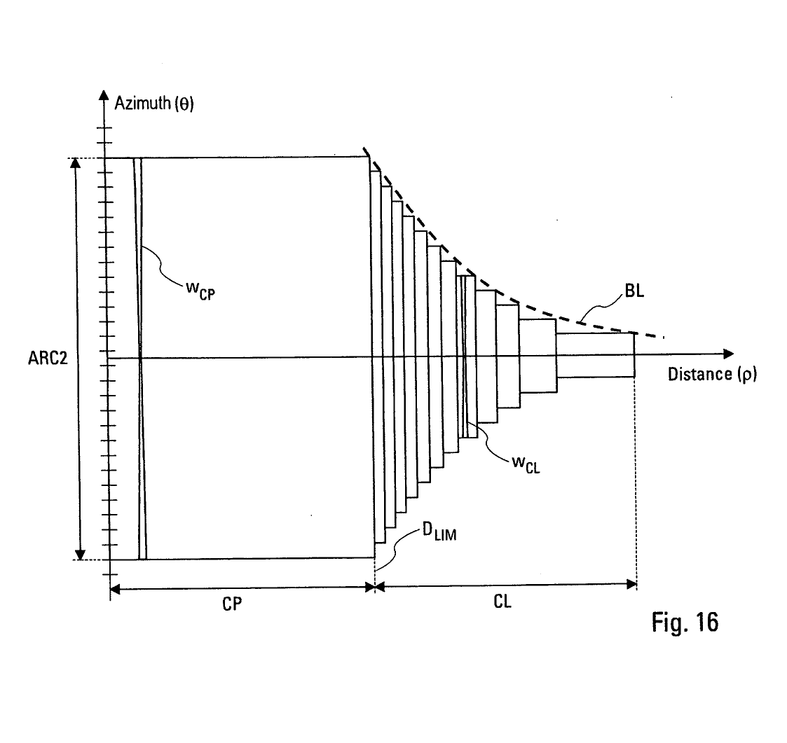

FIG. 16, an exemplary advantageous implementation of the invention, in which the azimuthal width of the sliding windows, that is to say the number of recurrences used, is tailored to the radio link budget.

We now refer to FIG. 1 in which is represented an example of recurrences of a secondary radar.

Each recurrence comprises an interrogation emitted by the secondary radar. The radar can be a rotating-antenna radar. Each interrogation is therefore emitted in an azimuthal direction denoted θₙ, where the index n represents the recurrence number. The azimuthal direction is that defined by the direction of the main lobe of the antenna during the interrogation. Interrogations Iₙ can be emitted in various modes. We have represented an interrogation succession in mode A and in mode C emitted alternately. The interrogation can be formed by two pulses P₁, P₃, separated by a determined time interval. For example, the pulses of the interrogations in mode A are separated by 8 μs, and those in mode C by 21 μs. Of course, the invention is not limited to these interrogation modes.

The recurrences comprise responses. These responses are emitted by transponders situated in the reception lobe of the antenna, and received by the secondary radar. Some responses may be synchronous, such as the responses R₁ to R₄, that is to say emitted by transponders in response to the interrogations Iₙ. The responses R₁ to R₄ in this example are emitted by one and the same transponder, responding at one and the same time to the mode A and mode C interrogations. Other responses may be asynchronous, such as the responses R₅ to R₇, that is to say emitted by transponders in response to interrogations of one or more other secondary radars.

A conventional response (synchronous or asynchronous) comprises two framing pulses, denoted F₁ and F₂, separated by a determined time interval. This interval can be 20.3 μs for the responses to the mode A and C interrogations. Between the two framing pulses, the responses furthermore comprise pulses (not represented) coding for data.

A recurrence period is defined by the time separating two pulses P₃ of two successive interrogations. This period is of the order of 2 to 20 ms. It is possible to effect a wobbulation, with for example 128 wobbulation porches, that is to say use a variable recurrence period. This makes it possible to more effectively eliminate the asynchronous responses arising from other radars having an interrogation frequency close to that of the radar equipped with the defruiter.

FIG. 2 represents an exemplary receiver of a secondary radar. This receiver comprises a device for processing the pulses 10 which receives, as input, signals (radar video) reckoned in a manner known per se, sampled at a frequency of for example 20 MHz.

One of these signals represents an item of information conventionally termed Log sigma. This signal is representative of the power of the received signal after it has been amplified in a known manner by a logarithmic amplifier. It is converted into a digital quantity by an analog-digital converter (not represented) before its introduction into the device 10. The device 10 also receives a signal conventionally termed Q sigma, which is the copy of the signal Log sigma decreased by six decibels. This signal Q sigma makes it possible to obtain the mid-point of the value of the power of the pulse. The device 10 also receives a signal QRSLS termed reception on sidelobes.

The device 10 makes it possible in particular to reckon the position of the pulses. This reckoning can be done by taking account of the detection of real rising edges on the one hand, and on the other hand by generating artificial rising edges when a real pulse has a duration greater than the normal duration of a pulse. This generation can be done on the basis of the rear edge of the real pulse. If a change of power level is detected, this generation can also be done on the basis of the moments of this change of power. The normal duration of a pulse may be known from the international standardization, such as the International Civil Aviation Convention, also called the ICAO standard (International Civil Aviation Organization), annex 10 (Aeronautical Telecommunications), volume IV (Surveillance radar and anti-collision systems).

The receiver furthermore comprises a device for detecting secondary responses 60, placed downstream of the device 10. The detection device 60 is also called a BPD detector (the acronym standing for the expression “Bracket Pair Detection”) or secondary responses detector. The circuit 60 makes it possible to detect the coincidence of pulses separated by the determined interval, that is to say 20.3 μs in this example. It essentially comprises a delay line with a delay of 20.3 μs whose input receives the sampled radar video signal. Advantageously, a tolerance time (for example 0.25 μs) is added to this duration of 20.3 μs. This tolerance time makes it possible to take account of the response time of the transponders and of the uncertainty introduced by the upstream detection circuit. The input and the output of the delay line are linked to an “AND” logic gate, whose output makes it possible to detect the coincidence of framing pulses, and therefore of a response.

The receiver furthermore comprises a device 20 which on the basis of the information of the device 10 reckons the messages contained in each of the responses received.

Before transmitting these responses to the processing or display devices, it is appropriate to be certain that the responses detected are not asynchronous responses. This function is carried out by a defruiter. A defruiter comprises devices 30, 40, 70, 80. The devices 30 and 70 are memories containing respectively messages and detections arising from the devices 20 and 60.

The device 80 is a correlator for effecting a correlation between a current detection and other detections, which are stored in the memory 70. This correlation amounts to counting in determined recurrences the number of responses regarded as synchronous with a current response. The choice of the recurrences can be performed in the manner described in the document FR 2 692 996 (mono-mode, multi-mode). To determine whether two responses are synchronous, we perform a test called a synchronism test. The implementation of this test amounts to determining a window as a function of the position of the current response (recurrence, distance slot) in the memory 70. The correlation being performed for each response detected, a sliding window is used.

The result of the correlation carried out feeds a fruit elimination device 40. This device receives response messages originating from the memory 30. This memory 30 has the function of preserving the messages received for the time required for the execution of the correlation. The device 40 transmits the messages of the correlated responses to a device for generating blips 50. On the other hand, it does not transmit the message of a response regarded as asynchronous as it has not been correlated.

We now refer to FIG. 3 in which is represented an exemplary sliding window used to perform a synchronism test in a defruiting method of the prior art. The description of such a method will be found in patent FR 2 692 996. The output of the BPD detector can be linked to a matrix memory whose memory slots are represented in a azimuth-distance reference frame. The matrix memory makes it possible to store the response detections (synchronous or asynchronous).

The memory slots are ordered distance-wise and recurrence-wise. Each column of the matrix memory represents a distance slot. Each column corresponds to a return-trip distance, traversed by a wave at the speed of light, denoted c, for 50 nanoseconds (if the signal processing frequency chosen is 20 MHz). For a range of 265 nautical miles there are 65536 columns. Each row of the memory represents a recurrence. Each row corresponds to the azimuth of the main lobe of the antenna during the interrogation.

When a memory slot of row No. i is filled in, this indicates that a response has been detected by the BPD detector during recurrence No. i. The row of the memory slot makes it possible to determine the azimuth θᵢ of the radar during the interrogation. The column of the memory slot makes it possible to determine the distance ρⱼ, expressed as a number of memory slots, between the transponder and the radar.

When a response is detected in a recurrence, we investigate whether this response is correlated with other responses in other recurrences. Stated otherwise, we perform a synchronism test between a detection under analysis and other detections produced in other recurrences. The recurrences taken into consideration to perform the synchronism test can be those which precede and/or those which follow the detection under analysis. In this example, the response under analysis is referenced by the azimuth θᵢ and the distance ρᵢ.

We take into consideration the N recurrences which precede and the N recurrences which follow the response under analysis. These N recurrences correspond to an azimuthal extent Δθ equal to the antenna lobe width used by the radar. For example, it is possible to use a value of N equal to thirteen.

In these other recurrences, the responses are regarded as synchronous if they are received in time intervals [T−τ; T+τ], τ designating a tolerance time. The time tolerance τ corresponds to a distance tolerance δρ with:

$$δ ρ = \frac{c \times τ}{2}$$

In this example, the tolerance δρ is four distance slots. Thus, we take into consideration not only the distance slot of the response under analysis, but also the four distance slots which precede it and which follow it. However, these four distance slots are not sufficient to take account of the transponders imbued with a non-negligible radial speed.

We refer to FIG. 1. We consider a transponder approaching. From recurrence to recurrence, the distance between the transponder and the radar decreases. Thus at recurrence No. i the distance is ρᵢ. At recurrence No. j, the distance has decreased to ρⱼ, the gap between ρᵢ and ρⱼ being greater than four distance slots.

As illustrated in FIG. 3, the approaching transponder exits the sliding window. The detections at the following recurrences are not taken into consideration. As a result thereof, if the number of detections is too low, such a transponder may not be detected. Stated otherwise, the responses corresponding to this approaching transponder, regarded wrongly as asynchronous, will be eliminated by a conventional defruiting method.

We refer now to FIGS. 4 to 6. The invention makes it possible to take account of all the detections of a mobile transponder. The radial speed of the transponder, assumed constant, is flanked by two radial speeds Vₘᵢₙ and Vₘₐₓ. Vₘᵢₙ represents the minimum radial speed, Vₘₐₓ the maximum radial speed. The speeds Vₘᵢₙ and Vₘₐₓ are parameters of the method, at least one of these speeds being nonzero. By convention, the radial speed is taken positive for an approaching transponder and negative for a receding transponder. Thus, a transponder which is receding has a smaller radial speed than an approaching transponder.

When a response is detected in a recurrence, we investigate whether this response is correlated with other responses in other recurrences by performing a synchronism test of the type of that described previously. According to the invention, when we perform the synchronism test, we take account of the detections of the transponders whose radial speeds lie between the speeds Vₘᵢₙ and Vₘₐₓ.

When a response at recurrence No. i is detected, we regard as synchronous with recurrence No. j the responses for which:
ρⱼε└ρᵢ−Vₘₐₓ×(tⱼ−tᵢ);ρᵢ−Vₘᵢₙ×(tⱼ−tᵢ)┘ when tⱼ>tᵢ,
or
ρⱼε└ρᵢ−Vₘᵢₙ×(tⱼ−tᵢ);ρᵢ−Vₘₐₓ×(tⱼ−tᵢ)┘ when tⱼ<tᵢ,
where tᵢ and tⱼ are respectively the instant of emission of the interrogation in recurrence i and in recurrence j.

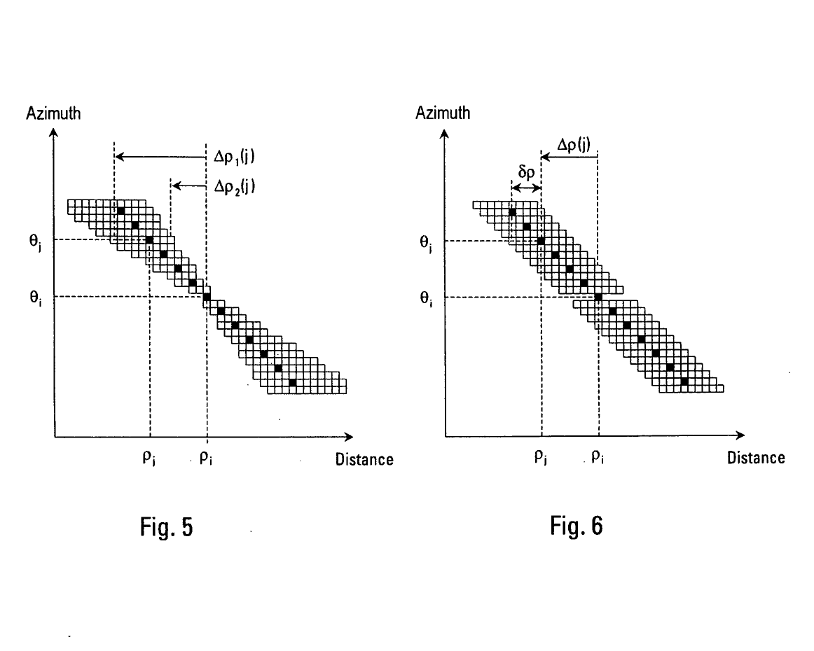

The speeds Vₘᵢₙ and Vₘₐₓ may be different or equal. In the examples illustrated in FIGS. 4 and 5, we use different speeds. At recurrence j, the synchronism test amounts to regarding as synchronous the detections in the distance slots going from ρᵢ+Δρ₁(j) to ρᵢ+Δρ₂(j), where:
Δμᵢ(j)=−Vₘₐₓ×(tⱼ−tᵢ) and Δρ₂(j)=−Vₘᵢₙ×(tⱼ−tᵢ) when tⱼ>tᵢ
or
Δρᵢ(j)=−Vₘₐₓ×(tⱼ−tᵢ) and Δρ₂(j)=−Vₘᵢₙ×(tⱼ−tᵢ) when tⱼ>tᵢ

In the example illustrated in FIG. 4, we use parameters having the same absolute value. Stated otherwise, the transponders are assumed to have a radial speed limited in absolute value to a speed Vᵣ. We therefore use the parameters Vₘᵢₙ=−Vᵣ and Vₘₐₓ=+Vᵣ. We obtain a sliding window having an hourglass shape.

In the example illustrated in FIG. 5, we use parameters having closely similar values. Stated otherwise, we flank the radial speed between two closely similar values.

In the example illustrated in FIG. 6, we use parameters having the same value. The synchronism test amounts to searching for the transponders detected at a determined distance ρⱼ=ρᵢ+Δρ(j) with:
Δρ(j)=−Vₘᵢₙ×(tⱼ−tᵢ)=−Vₘₐₓ×(tⱼ−tᵢ)

According to an advantageous embodiment, a distance tolerance δρ is used to perform the synchronism test. Stated otherwise, we regard as synchronous with recurrence No. j responses for which:
ρⱼε└ρᵢ−Vₘₐₓ×(tⱼ−tᵢ)−δρ;ρᵢ−Vₘᵢₙ×(tⱼ−tᵢ)+δρ┘ when tⱼ>tᵢ,
or
ρⱼε└ρᵢ−Vₘᵢₙ×(tⱼ−tᵢ)−δρ;ρᵢ−Vₘₐₓ×(tⱼ−tᵢ)+δρ┘ when tⱼ<tᵢ,

In the example illustrated in FIG. 6, we use a fixed tolerance of four distance slots. We obtain a parallelogram-shaped sliding window. This embodiment corresponds to a single radial speed, that is to say to a value of Vₘᵢₙ equal to Vₘₐₓ. This embodiment is optimal when the speed of the aircraft is known.

The embodiments described in conjunction with FIGS. 5 and 6 are useful when using several synchronous filters (that is to say filters of secondary responses) in parallel. According to an advantageous embodiment of the invention, the synchronous filters are distributed speed-wise so as to detect the synchronism of responses of transponders imbued with radial speeds included in contiguous bins. According to another advantageous embodiment, the radial speed bins are equidistributed.

The effectiveness of a defruiter, that is to say the rate of removal of the asynchronous responses, is all the lower the larger the correlation area employed and the higher the rate of asynchronous responses. The invention makes it possible, in a radar environment very polluted by asynchronous responses, to obtain better effectiveness by the use of a correlation area tailored to the useful target.

We refer now to FIGS. 7 to 13 in which is represented a set of sliding windows W₁, W₂, . . . , W₇ according to the invention. The sliding windows are represented in azimuth-distance reference frames centered on the response under analysis. Each sliding window is used to effect a different synchronous filter, to which there corresponds a different radial speed bin. The radial speed bins are represented on an axis parallel to the distance axis (abscissa axis). The ends of these bins are denoted V₁, V₂, . . . , V₈. Thus, the sliding window W₁ corresponding to the bin of radial speeds [V₁; V₂]. The following sliding window W₂ corresponds to a bin of contiguous radial speeds [V₂; V₃] . . . We thus produce a set of synchronous filters whose corresponding radial speed bins are contiguous.

In an advantageous manner, each radial speed V₁, V₂, . . . , V₈ is separated from that which precedes by a fixed speed gap. Stated otherwise, the speed bins are equidistributed.

We refer to FIG. 14, a detail view of the sliding window W₇ represented as a whole in FIG. 13. In this exemplary implementation, a distance tolerance δρ is used to perform the synchronism test. Thus, the sliding window W₇ comprises an internal limit Lᵢₙₜ corresponding exactly to the radial speed V₈, and an external limit Lₑₓₜ corresponding to this same radial speed taking account of a distance tolerance δρ. This additional tolerance is aimed at taking account of the jitter in the response time of the transponder as well as the jitter introduced by the processings of the receiver such as those due to the receiver sampling frequency.

Thus, the sliding windows W₁, W₂, . . . , W₇ can be defined by:
ρⱼε└ρᵢ−Vₘₐₓ×(tⱼ−tᵢ−δρ;ρᵢ−Vₘᵢₙ×(tⱼ−tᵢ)+δρ┘ when tⱼ>tᵢ,
or
ρⱼε└ρᵢ−Vₘᵢₙ×(tⱼ−tᵢ)−δρ;ρᵢ−Vₘₐₓ×(tⱼ−tᵢ)+δρ┘ when tⱼ<tᵢ,
with
for W₁: Vₘᵢₙ=V₁ and Vₘₐₓ=V₂;
for W₂: Vₘᵢₙ=V₂ and Vₘₐₓ=V₃;
   . . .
for W₇: Vₘᵢₙ=V₇ and Vₘₐₓ=V₈.

Thus the correlation bin is each time tailored to the speed of the target, all the more so as Vᵢ₊₁−Vᵢ is small. A response will be declared synchronous if the correlation threshold is exceeded for one of the filters of the bank.

We now refer to FIG. 15 in which is represented an example of antenna patterns of a secondary radar in a power-azimuth reference frame, the power being represented as ordinate on a logarithmic scale. The radar emits and receives radio waves by using three different antenna patterns, conventionally called the sum Σ, difference Δ and control Ω. The sum antenna pattern is centered with respect to the radioelectric axis AR of the antenna. The difference antenna pattern comprises two sidelobes that are symmetric with respect to the axis AR. The control antenna pattern for its part exhibits a minimum centered on the radioelectric axis AR and a plateau off this axis.

The pulses (P₁, P₃) forming the interrogations are emitted using the sum pattern. In certain applications, pulses may also be emitted using the difference pattern. The use of the difference pattern on emission is optional. During each interrogation, a control pulse (P₂), defined by the ICAO standard, is emitted using the control pattern.

The ICAO standard requires that the transponders respond to the interrogations only in a predetermined arc of the antenna pattern of the secondary radar. According to the standard, when a transponder receives a pulse (P₁), from the sum channel, whose power is 9 dB greater than that of the pulse from the control channel (P₂), the transponder must respond to the interrogation. This condition corresponds to an azimuth arc ARC1 in which the standard guarantees the responses of the transponders. On the other hand if the power of the pulse P₁ is less than that of the pulse P₂, the transponder must not respond to the interrogation. There thus exists an uncertainty zone ZI, when the power of the pulse received on the sum channel is in an interval from 0 to 9 dB above the power of the control pulse. In this uncertainty zone, the transponder may or may not respond to the interrogation. By adding these uncertainty zones ZI to the of previously defined azimuth arc ARC1, we obtain a maximum azimuth arc ARC2 beyond which no transponder may respond.

According to an advantageous embodiment, the synchronism test is performed by only using the recurrences included in the arc ARC2 with respect to the response under analysis. This makes it possible to improve the probability of detecting the synchronous transponder responses having a low response rate to the interrogations of the radar but responding over a maximum arc. Stated otherwise, the quantity ARC2 makes it possible to define the number N of recurrences which precede or follow the response under analysis.

We now refer to FIG. 16 in which is represented an advantageous exemplary implementation of the invention, in which the azimuthal width of the sliding windows, that is to say the number of recurrences used, is tailored to the radio link budget. On the basis of a distance D_{LIM} dependent on the characteristics of the secondary radar and the transponders, the width of the lobe is no longer limited by the ICAO standard but by the link budget. The transponders situated short of this distance are said to be in the near field CP. The transponders situated beyond this distance are said to be in the far field CL. In the near field CP, the azimuth arc in which the transponders can respond is limited by the standard (see FIG. 14). In the far field CL, it is the range of the secondary radar-transponder system, that is to say the link budget BL, which limits the width of the lobe. In the far field, at the limits of the effective lobe of the secondary radar, either the transponder does not manage to receive the interrogations originating from the secondary radar, or the secondary radar does not manage to receive the responses originating from the transponders.

According to the advantageous embodiment represented in FIG. 16, the azimuthal extent of the sliding windows is tailored to the link budget. Stated otherwise, the synchronism test is performed in the far field only on the recurrences for which the interrogation azimuth lies in the effective interrogation lobe of the secondary radar. This limitation of the correlation zone to the response arc of the transponder makes it possible not to impair the probability of detection of the synchronous responses but also to increase the effectiveness of the defruiter according to the invention.

In this figure, the ordinate axis represents the interrogation azimuth, and the abscissa axis the radial distance of the transponders. The ordinate axis is graduated in terms of recurrence. An exemplary W_{CP} sliding window is represented in the near field CP. This sliding window includes the thirteen recurrences which follow and which precede the response under analysis. Another exemplary W_{CL} sliding window is represented in the far field CL. This sliding window is limited to the five recurrences which follow and which precede the response under analysis. This figure is not to scale, the distance-wise width of the sliding windows being exaggerated so as to render them visible.

According to another advantageous embodiment (not represented), it is possible to also limit the width of the sliding windows by taking account not only of the azimuth, but also of the elevation of the transponders with respect to the secondary radar. Specifically, the elevation of the transponders intervenes also (to a lesser degree) in the link budget according to the elevation pattern of the antenna of the radar.

Of course, the invention is not limited to these exemplary embodiments. The sliding windows have been represented in an azimuth-distance reference frame by assuming that the secondary radar is a radar with antenna rotating at a constant speed. However, the invention applies also to radars with fixed antenna. In this case, it is possible to replace the ordinate axis (azimuth during interrogation) with a time axis, the time on this axis being the instant of the interrogation.

1-8. (canceled)

9. A method for defruiting the transponder responses received by a secondary radar in response to interrogations emitted by the radar in a recurrent manner, a recurrence being formed by the interrogation and the responses received in the course of a listening period following the interrogation, the defruiting method comprising a test of the synchronism of the responses received in various recurrences, a first response received in a recurrence i being considered synchronous with a second response received in another recurrence j if:
ρⱼε└ρᵢ−Vₘₐₓ×(tⱼ−tᵢ);ρᵢ−Vₘᵢₙ×(tⱼ−tᵢ)┘ when tⱼ>tᵢ, or
ρⱼε└ρᵢ−Vₘᵢₙ×(tⱼ−tᵢ);ρᵢ−Vₘₐₓ×(tⱼ−tᵢ)┘ when tⱼ<tᵢ,
where:
Vₘᵢₙ and Vₘₐₓ are respectively the minimum and maximum radial speed of the transponders with respect to the secondary radar, positive by convention for a transponder approaching the radar, the speeds Vₘᵢₙ and Vₘₐₓ possibly being equal, at least Vₘᵢₙ or Vₘₐₓ being nonzero;
ρᵢ and ρⱼ are respectively the distance at which the transponder has been detected in recurrence i and in recurrence j;
tᵢ and tⱼ are respectively the instant of emission of the interrogation in recurrence i and in recurrence j.

10. The method as claimed in claim 9, wherein a distance tolerance is used to perform the synchronism test.

11. A method of defruiting in which defruiting methods as claimed in claim 9 are applied in parallel to different radial speed bins [Vmin; Vmax].

12. The method as claimed in claim 11, wherein the radial speed bins are contiguous.

13. The method as claimed in claim 11, wherein the radial speed bins are equidistributed.

14. The method as claimed in claim 9, wherein the synchronism test is performed in the far field only on the recurrences for which the interrogation azimuth lies in the effective interrogation lobe of the secondary radar.

15. A defruiter for extractor of transponder responses comprising a correlation device configured to implement the method as claimed in claim 9.

16. A secondary radar comprising a defruiter as claimed in claim 15.
